(19) United States
(12) Patent Application Publication
(10) Pub. No.: US 2026/0352965 A1
(43) Pub. Date: Nov. 5, 2026

(54) IMAGING DEVICE AND METHOD FOR CONTROLLING IMAGING DEVICE

(71) Applicant: Maxell, Ltd., Kyoto (JP)

(72) Inventors: Soichi MATSUDA, Tokyo (JP); Hiroyuki TOKUNAGA, Tokyo (JP); Kei YAMAHASHI, Tokyo (JP)

(21) Appl. No.: 19/125,499

(22) PCT Filed: Oct. 5, 2023
(86) PCT No.: PCT/JP2023/036403

§ 371 Date: Apr. 29, 2025

(30) Foreign Application Priority Data
Oct. 31, 2022 (JP) 2022-174141

(51) Int. Cl. H04N 23/84; H04N 23/60; H04N 25/772

(52) U.S. Cl. CPC H04N 23/843; H04N 23/60; H04N 25/772

(57) ABSTRACT

An imaging device including an image sensor that includes a plurality of pixels used for converting a subject image into an electrical signal, the imaging device including: a first machine learning arithmetic operation means for processing signals acquired from the plurality of pixels using a first machine learning model including a plurality of arithmetic operation layers; a determination means for determining whether or not processing is executed using the first machine learning arithmetic operation means; and a second machine learning arithmetic operation means for processing on the basis of the signals or a processing result acquired by the first machine learning arithmetic operation means using a second machine learning model different from the first machine learning model, in which the first machine learning model includes a quantization operation layer performing a quantization operation on an arithmetic operation result of a convolution operation layer performing at least a convolution operation.

### CROSS-REFERENCE TO RELATED APPLICATIONS

This application is the U.S. National Stage entry of International Application No. PCT/JP 2023/036403, filed on Oct. 5, 2023, which, in turn, claims priority to JP Patent Application No. 2022-174141, filed on Oct. 31, 2022, both of which are hereby incorporated herein by reference in their entireties for all purposes.

### TECHNICAL FIELD

The present invention relates to an imaging device and a method for controlling an imaging device.

### BACKGROUND ART

In recent years, Convolutional Neural Networks (CNN) have been used as models for image recognition and the like. Convolutional neural networks have multilayered structures having a convolutional layer, a pooling layer, and the like and require many arithmetic operations in parallel. Various arithmetic operation techniques have been devised to speed up arithmetic operations using convolutional neural networks (Patent Document 1 and the like).

### CITATION LIST

### Patent Document

Patent Document 1: Japanese Unexamined Patent Application, First Publication

### SUMMARY OF INVENTION

### Technical Problem

On the other hand, also in embedded devices such as IoT devices, image recognition, image quality improvement processing, and the like using convolutional neural networks are performed. In order to realize such a convolutional neural network, an accelerator with high versatility in addition to high speed and power saving is required. However, there is a trade-off between respective performances, and a certain amount of redundancy is necessary especially for improving versatility, which leads to a reduction in computing efficiency for the circuit scale or the power consumption. For this reason, it is preferable for accelerators processing CNNs to have versatility in addition to high speed and power saving.

Based on the circumstances described above, an objective of the present invention is to provide an imaging device that is capable of acquiring images as an IoT device and performs arithmetic operations relating to machine learning on the acquired images with high efficiency and high speed and a method for controlling an imaging device for operating circuits and models, which perform arithmetic operations relating to machine learning, with high efficiency and high speed.

### Solution to Problem

In order to solve the problems described above, the present invention proposes the following means.

According to an embodiment of the present invention, there is provided an imaging device including an image sensor that includes a plurality of pixels used for converting a subject image into an electrical signal, the imaging device including: a first machine learning arithmetic operation means for processing signals acquired from the plurality of pixels using a first machine learning model including a plurality of arithmetic operation layers; a determination means for determining whether or not processing is executed using the first machine learning arithmetic operation means; and a second machine learning arithmetic operation means for processing on the basis of the signals or a processing result acquired by the first machine learning arithmetic operation means using a second machine learning model different from the first machine learning model, in which the first machine learning model includes a quantization operation layer performing a quantization operation on an arithmetic operation result of a convolution operation layer performing at least a convolution operation.

### Advantageous Effects of Invention

An imaging device and a method for controlling an imaging device according to the present invention can provide an imaging device that is capable of acquiring images as an IoT device and performs arithmetic operations relating to machine learning on the acquired images with high efficiency and high speed and a method for controlling an imaging device for operating circuits and models, which perform arithmetic operations relating to machine learning, with high efficiency and high speed.

### BRIEF DESCRIPTION OF DRAWINGS

FIG. 1 is a functional block diagram of an imaging device according to a first embodiment.

FIG. 2 is a functional block diagram of a sensor according to the first embodiment.

FIG. 3 is a functional block diagram of a first machine learning arithmetic operation unit according to the first embodiment.

FIG. 4 is a timing chart for describing an operation of a buffer according to the first embodiment.

FIG. 5 is a diagram illustrating a network structure of a machine learning model according to the first embodiment.

FIG. 6 is a functional block diagram of a second machine learning arithmetic operation unit according to the first embodiment.

FIG. 7 is a diagram illustrating each arithmetic operation layer of a feature extracting unit according to the first embodiment.

FIG. 8 is a flowchart for describing a method for controlling an imaging device according to the first embodiment.

FIG. 9 is a functional block diagram of an imaging device according to a second embodiment.

FIG. 10 is a timing chart for describing operations of a buffer and an ISP according to the second embodiment.

FIG. 11 is a functional block diagram of an imaging device according to a third embodiment.

FIG. 12 is a functional block diagram of an imaging device according to a fourth embodiment.

### DESCRIPTION OF EMBODIMENTS

### First Embodiment

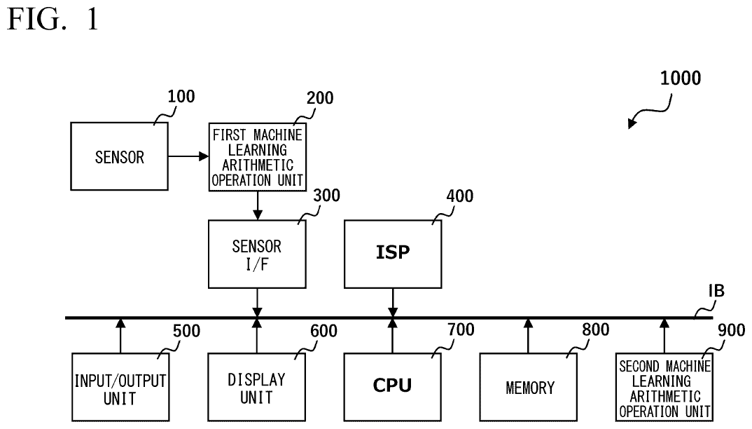

Embodiments of the present invention will be described with reference to FIGS. 1 to 8. FIG. 1 is a diagram illustrating an imaging device 1000 according to this embodiment.

### Imaging Device 1000

FIG. 1 is a functional block diagram of the imaging device according to this embodiment. The imaging device 1000 according to this embodiment will be described with reference to the drawing. The imaging device 1000 is a device for acquiring a subject image generated by a predetermined light collecting device such as an optical member including a lens and the like and, as an example, is a digital camera, a surveillance camera, an in-vehicle camera, or the like, and the present invention can be applied to any device such as a smartphone or a robot as long as it includes an imaging means. It is appropriate to apply the invention according to this embodiment to products such as embedded devices of which the amount of power consumption for battery driving and the like is limited.

The imaging device 1000 according to this embodiment includes a sensor 100, a first machine learning arithmetic operation unit 200, a sensor I/F 300, an ISP 400, an input/output unit 500, a display unit 600, a CPU 700, a memory 800, and a second machine learning arithmetic operation unit 900.

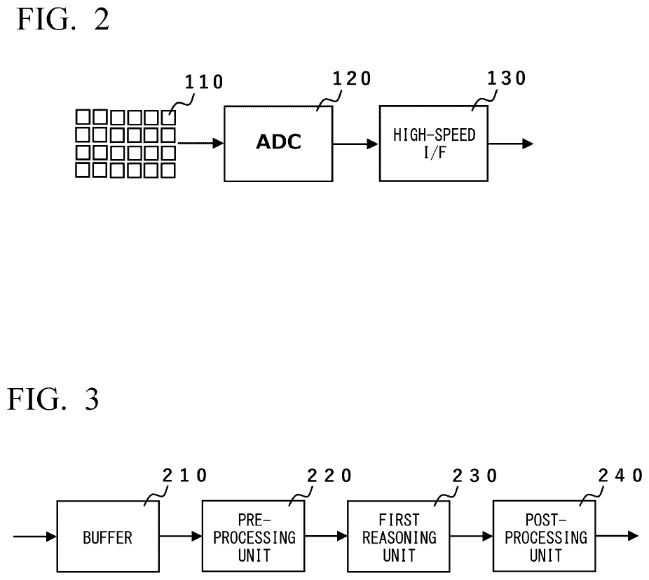

The sensor 100 is an object imaging element that converts a subject image formed by an optical means, which is not illustrated in the drawing, into an electrical signal through photoelectric conversion. One example of the sensor 100 is a CMOS image sensor. The sensor 100 according to this embodiment, as illustrated in FIG. 2, includes a plurality of pixels 110 of which the number of the pixels is at least larger than 2000×1500 pixels. Each pixel 110 includes a predetermined color filter, and the sensor 100 according to this embodiment includes a color filter of a so-called Bayer array. In addition, the sensor 100 includes an analog-to-digital conversion circuit (ADC) 120 that converts an analog electrical signal acquired through photoelectric conversion to a digital value on the basis of the timing of a synchronization signal generated by a sensor control unit, which is not illustrated in the drawing, controlled by the CPU 700 to be described below. Furthermore, the sensor 100 includes a multi-channel high-speed I/F 130 that is capable of outputting a multi-bit digital signal after conversion using the analog-to-digital conversion circuit 120 at a high speed.

Here, the analog-to-digital conversion circuit 120 included in the sensor 100 according to this embodiment has a resolution capable of converting each pixel value into a digital value of 12 bits or more and operates in a plurality of drive modes under control from a sensor control unit not illustrated in the drawing. As an example, the analog-to-digital conversion circuit 120 may have a mode in which signals from all the pixels 110 included in the sensor 100 are read out in a rolling shutter operation, and 12-bit digital values are output, a mode in which signals from some of the pixels 110 included in the sensor 100 are partially added or thinned out and read out, and 10-bit digital values are output, and the like. In addition, a mode in which 30 frames or 60 frames of pixel values of a 4K format or an 8K format are output during one second may be included as a high-quality video mode. The signal of each pixel 110 output by the sensor 100 is so-called raw image data and includes information having a bit precision of 12 bits or 14 bits.

The first machine learning arithmetic operation unit 200 is an arithmetic operation unit that takes raw image data that represents multi-bit digital values that are output of the sensor 100 as an input and executes an arithmetic operation on this input using a predetermined machine learning model. FIG. 3 is a functional block diagram of the first machine learning arithmetic operation unit 200. The first machine learning arithmetic operation unit 200 includes a buffer 210, a pre-processing unit 220, a first reasoning unit 230, and a post-processing unit 240.

The buffer 210 is a buffer that receives and temporarily maintains the output of sensor 100. The sensor 100 according to this embodiment repeatedly outputs pixel values of predetermined unit pixels at the period of a horizontal synchronization signal (HD). As an example, the sensor 100 sequentially outputs pixel values corresponding to one row in one horizontal synchronization signal period. In other words, in a case in which the sensor 100 includes pixels 110 of 1500 rows, 1500 pixel values of 12 bits or 14 bits more than 8 bits are output in one horizontal synchronization. Then, pixel values corresponding to one frame are output in a period corresponding to 1500 periods of the horizontal synchronization signal period. Particularly, in a case in which an image is processed using a machine learning model, a convolution operation is used, and thus pixel values corresponding to a plurality of rows need to be maintained. For this reason, the buffer 210 has a capacity capable of maintaining pixel values of a plurality of rows that are three rows or more.

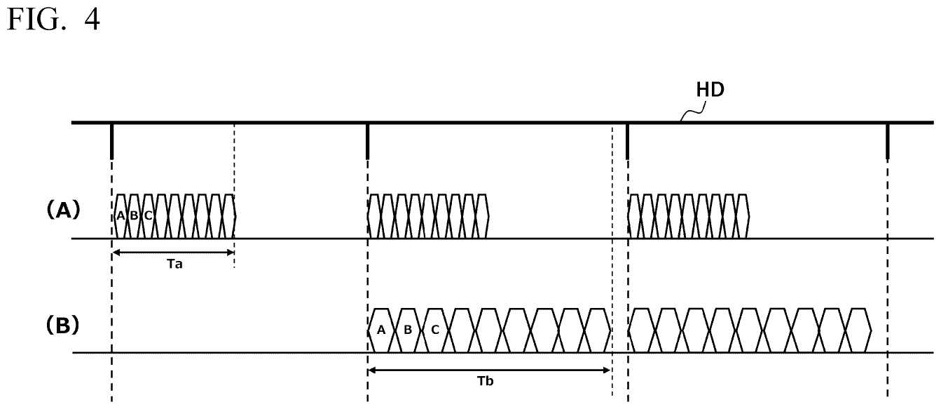

FIG. 4 is a timing chart for describing the operation of the buffer 210. For simplicity of description, an example in which pixel values corresponding to one row are maintained by the buffer 210 is illustrated in this embodiment. The sensor 100 outputs pixel values corresponding to one screen at the period of the vertical synchronization signal VD. Then, the period of the vertical synchronization signal VD is divided into a plurality of horizontal synchronization signal HD periods, and the sensor 100 outputs pixel values of a predetermined unit (for example, one row) on the basis of the period of the horizontal synchronization signals HD. FIG. 4A illustrates data output timings of pixel values output from sensor 100. The sensor 100 outputs pixel value data sequentially as pixel A, pixel B, and pixel C in a period Ta in synchronization with the timing of the horizontal synchronization signal HD. After the period Ta during which the pixel value data is output, the sensor 100 performs a power-saving operation such as turning off the power of each block. For this reason, the shorter the period Ta by performing high-speed data transfer using a plurality of output CHs and the like, the more power reduction in the sensor 100 can be achieved. FIG. 4B illustrates data output timings of pixel values output from buffer 210. In synchronization with the timing of the horizontal synchronization signal HD, pixel value data is sequentially read out in a period Tb. In later stages of the buffer 210, the slower the peak value of the data rate to be processed, the more power reduction is achieved. For this reason, it is preferable to convert the data rate when data is read out from buffer 210. In other words, by slowing the data rate at the time of read-out compared with the data rate of the peak at the time of input during the period of the horizontal synchronization signal HD in the buffer 210, an effect of improving the processing efficiency can be acquired.

In FIG. 4, although an example in which the buffer 210 maintains pixel values corresponding to one row has been described, the configuration is not limited thereto, and in a case in which data regarding a plurality of rows is required for the first reasoning unit 230 to be described above, a plurality of rows may be configured to be maintained. For example, in a case in which 3×3 weights are used by the first reasoning unit 230 in the arithmetic operation, pixel values corresponding to at least three rows may be configured to be maintained. The unit in which pixel values are maintained in the buffer 210 may not be a row unit, and in a case in which the sensor 100 outputs pixel values in units of predetermined areas, a unit for maintaining this area may be used.

In FIG. 3, the pre-processing unit 220 takes the output of the buffer 210 as input and performs a predetermined process. Examples of the process performed by the pre-processing unit 220 are rearrangement of pixel values maintained in the buffer 210, correction of defective pixels, black level correction, fixed pattern noise correction, and the like. By executing a predetermined process in a stage prior to the first reasoning unit 230 to be described below, the processing accuracy of the first reasoning unit 230 can be improved. The predetermined process performed by the pre-processing unit 220 is a rule-based process, the correction of detective pixels is performed on the basis of comparison with surrounding pixels, and the correction of a fixed pattern noise is performed on the basis of a correction value calculated from a black level.

The first reasoning unit 230 includes a processing circuit that corrects pixel values through a reasoning process using a machine learning model. In this embodiment, the machine learning model included in the first reasoning unit 230 is embedded in a state in which learning has been completed on the basis of images captured in advance. For example, in a case in which learning is performed to reduce noise in an image using a machine learning model, it is possible to perform learning by preparing a low-sensitivity image with low noise and a high-sensitivity image with high noise using the same subject and the same exposure and reasoning the image with high noise from the image with low noise as teacher data. In addition to or in addition to learning for reducing noise, the machine learning model may perform learning for improving the quality of an image also in reducing blurring and optical aberrations in the image. The machine learning model included in the first reasoning unit 230 may be a neural network having a network structure such as a U-NET structure as an example.

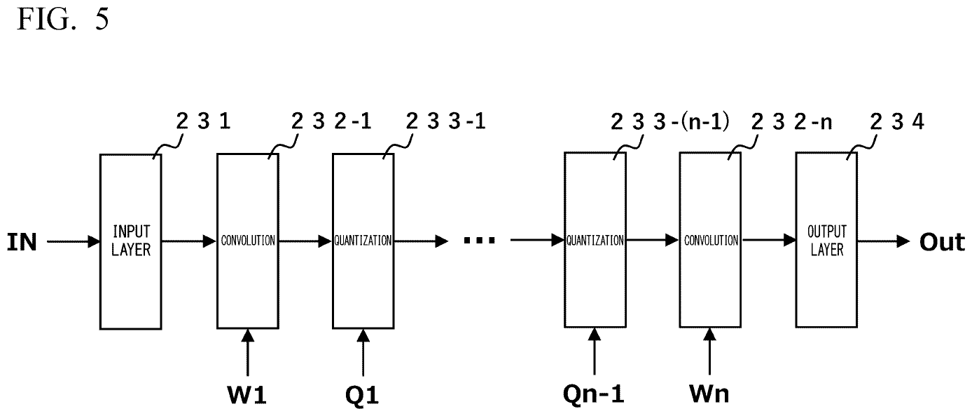

Here, the machine learning model included in the first reasoning unit 230 has a multilayer structure that includes a plurality of arithmetic operation layers and performs convolution operations using weights in each layer. FIG. 5 is a diagram illustrating a network structure of a machine learning model included in the first reasoning unit 230.

The machine learning model included in the first reasoning unit 230 includes an input layer 231, convolution operation layers 232, quantization operation layers 233, and an output layer 234 and includes a plurality of (n) convolution operation layers 232 and a plurality of (n) quantization operation layers 233, and each of the convolution operation layers 232 and each of the quantization operation layers 233 are alternately connected but may be connected with some layers thereof being skipped over. In addition, the machine learning model may further have layers with other functions such as a fully-coupled layer, a pooling layer, and the like. The machine learning model included in the first machine learning arithmetic operation unit 200 corresponds to a first machine learning model.

An input signal IN is input to the input layer 231. The input signal IN is a signal corresponding to a plurality of pixel values generated on the basis of the output of the pre-processing unit 220 and is a signal having a bit precision of 8 bits or more in this embodiment. The input layer converts each input signal IN into a vector having a plurality of elements. The converted vector is taken as an input of a convolution operation layer 232-1 of a first layer.

The convolution operation layer 232 performs a convolution operation using weights W on an input vector or a tensor (hereinafter referred to as an activation) acquired by combining a plurality of vectors. Particularly, an activation or a weight W used in an arithmetic operation is quantized into 8 bits or less in the convolution operation layer 232 according to this embodiment. As an example, the arithmetic operation is performed with the activation as a value quantized into 8 bits and the weight W as a value quantized into one bit. In this way, by performing an arithmetic operation using a small number of quantized bits, effects such as reduction of the size of a memory storing parameters, space saving of arithmetic operation circuits, improvement of an arithmetic operation speed, and the like can be acquired. Regarding activation, quantization may be performed up to 2 bits for the purpose of reducing an arithmetic operation load and the like.

The quantization operation layer 233 takes a convolution operation result in the convolution operation layer 232 as input and performs an arithmetic operation for quantization using a predetermined function. The quantized convolution operation result becomes an input to a next convolution operation layer 232. In this embodiment, each element of a matrix that is a convolution operation result output from the convolution operation layer 232 is a 16-bit integer, and a quantization result thereof has bits smaller than those of the input signal IN and is an 8-bit integer as an example. In this case, quantization is performed using a function represented in the following Equation 1. As a quantization method, a plurality of threshold values, tables, or the like may be used without using a function. In a case in which quantization into 2 bits is performed, it can be realized through comparison with three threshold values.

[Math 1]

F(x)=x/256 if x>0, else 0 (Equation 1)

As illustrated in FIG. 5, repetitive arithmetic operations are executed using a plurality of convolution operation layers 232 and quantization operation layers 233, and a result of the n-th convolution operation layer 232-n is input to the output layer 234. The output layer 234 outputs an arithmetic operation result in the machine learning model.

In FIG. 3, the post-processing unit 240 takes an arithmetic operation result of the first reasoning unit 230 as input, performs a predetermined process, and outputs the arithmetic operation result in synchronization with the horizontal synchronization signal. Examples of the process performed by the post-processing unit 240 in this embodiment are rearrangement of pixel values, addition and thinning-out of pixel values, serial signal conversion, addition of header information and a synchronization signal, and the like. In accordance with the process of the post-processing unit 240, data can be transferred to a block of a later stage at a high speed.

All or some of the functions of the first machine learning arithmetic operation unit 200 may be realized using hardware such as an application specific integrated circuit (ASIC), a programmable logic device (PLD), a field-programmable gate array (FPGA), or the like. In a convolution operation requiring many arithmetic operation resources, the first machine learning arithmetic operation unit 200 can reduce arithmetic operation resources by quantizing elements thereof. Since connection between the sensor 100 and the ISP 400 to be described below is performed using multi-channel high-speed communication, there is concern that the arrangement of a large-scale arithmetic operation circuit may cause a delay in the communication. However, by using a quantization technology, a reduction in the scale of this arithmetic operation circuit can be achieved, and an arithmetic operation in a machine learning model including a plurality of layers can be performed.

For example, in order to configure each function of the first machine learning arithmetic operation unit 200, a processor executing program processing and an accelerator executing an arithmetic operation relating to a neural network may be combined. More specifically, a neural network arithmetic operation accelerator used for repeatedly executing a convolution operation and a quantization operation may be used in combination with a processor.

Referring back to the description of FIG. 1, the configuration of the imaging device 1000 will be further described in detail. In this embodiment, the sensor I/F 300, the ISP 400, the input/output unit 500, the display unit 600, the CPU 700, the memory 800, and the second machine learning arithmetic operation unit 900 are configured on the same silicon chip, and each thereof is connected to a high-speed internal bus IB. In a case in which a communication means capable of sufficiently performing high-speed data communication is used, they may not be configured on the same silicon chip.

The sensor I/F 300 receives the output of the first machine learning arithmetic operation unit 200 and outputs the data to the internal bus IB. As an example, the sensor I/F 300 outputs data received from the first machine learning arithmetic operation unit 200 to the memory 800 such that the data is used in a process of a later stage. As another example, the sensor I/F 300 outputs the data received from the first machine learning arithmetic operation unit 200 to the ISP 400 to be described below to execute a predetermined image processing. In addition, in the sensor I/F 300, a buffer used for temporarily storing data for data format conversion and the like may be provided.

The ISP 400 is an image processing unit that selectively performs predetermined image processing on data based on pixel values (hereinafter referred to as image data) acquired by the sensor 100. As an example, demosaic processing, encoding and compression processing, color adjustment processing, gamma correction processing, and the like are performed. Each process is pipelined, consistently executes processing on input image data, and outputs a processing result. The processing result acquired in the ISP 400 may be output externally through the input/output unit 500 or may be displayed on the display unit 600.

The input/output unit 500 performs communication for image data and the like between the imaging device 1000 and an external device not illustrated in the drawing.

As a communication method, a wired means using a cable or the like may be used, or radio communication not using a cable and the like may be used. In addition, the input/output unit 500 may be configured to receive programs of commands including operation instructions and the like from external devices, a machine learning model operating in the imaging device 1000, various parameters, and the like other than the image data.

The display unit 600 includes a display used for displaying image data captured by the imaging device 1000 and the like and displays predetermined UI/UX, notifications, and the like in addition to the image data. In addition, by providing a touch panel on the display of the display unit 600, the display unit 600 may be used as an operation unit.

The CPU 700 is a control unit including a processor that performs overall control of each block of the imaging device 1000. By executing a program stored in the memory 800 in advance, the CPU 700 realizes various functions. As an example, the CPU 700 performs control of switching the operation mode of the imaging device 1000 on the basis of a user instruction from an operation unit not illustrated in the drawing.

The operation mode includes a still image mode, a moving image mode, a night view mode, and the like. By setting a machine learning model stored in the memory 800 in advance in the first machine learning arithmetic operation unit 200 or the second machine learning arithmetic operation unit 900 in accordance with the operation mode, the CPU 700 performs control of the machine learning arithmetic operation. The CPU 700 may be configured to include a sensor control unit that generates and supplies clocks and synchronization signals for controlling the imaging device 1000 as a control unit.

The memory 800 is configured using a DRAM or the like and stores firmware used for performing overall control of the imaging device 1000, UI data, data relating to the operation mode, data relating to the machine learning model, and the like in a plurality of storage areas. In this embodiment, network information, weights, quantization parameters, and the like are included in the data relating to the machine learning model. The memory 800 includes areas for storing image data, and the areas include a buffer area during an arithmetic operation, a storage area for storing still images and moving images that have been captured, and the like. In this embodiment, the memory 800 corresponds to a storage means for storing various kinds of data including image data and programs.

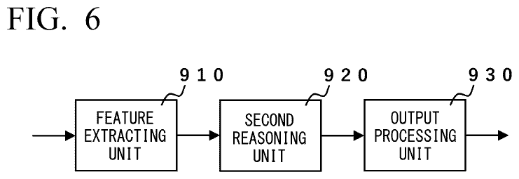

The second machine learning arithmetic operation unit 900 is an arithmetic operation unit that takes image data after being processed by the ISP 400 as input and executes an arithmetic operation using a predetermined machine learning model on this input. FIG. 6 is a functional block diagram of the second machine learning arithmetic operation unit 900. The second machine learning arithmetic operation unit 900 includes a feature extracting unit 910, a second reasoning unit 920, and an output processing unit 930. Each block performs a process on the basis of a clock signal that is the same as that of the CPU 700 or a multiplied clock signal thereof. A machine learning model included in the second machine learning arithmetic operation unit 900 is different from the U-NET structure and, for example, may have a network structure such as a transformer structure, a recurrent neural network structure, or the like.

The feature extracting unit 910 includes a processing circuit that performs a feature extraction process using a machine learning model. In this embodiment, the feature extracting unit 910 is embedded in a state in which learning has been completed on the basis of images captured in advance. For example, in a case in which learning is performed such that an intended object is detected using a machine learning model detecting an object within an image, learning can be performed by preparing a plurality of annotated images and detecting an object using annotation results as teacher data. The machine learning model may be configured to also perform learning for posture detection, object recognition, object tracking, and improving the quality of an image for reducing of blur and reducing optical aberration within an image other than the object detection. The feature extracting unit 910 includes a plurality of convolution operation layers L and sequentially performs an arithmetic operation on each thereof. A result of execution of the arithmetic operation is output as a feature quantity map.

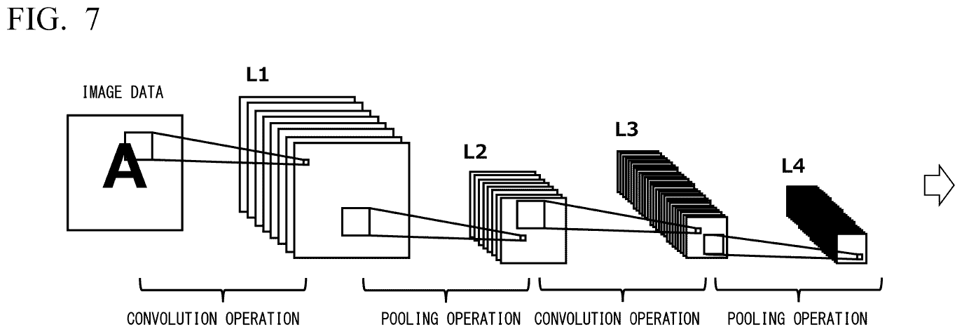

FIG. 7 is a diagram illustrating each arithmetic operation layer L of the feature extracting unit 910 according to this embodiment. In the feature extracting unit 910, repetitive arithmetic operations are performed on input image data using a layer that performs a convolution operation and a layer that performs a pooling operation. In the feature extracting unit 910 according to this embodiment, a size corresponding to vertical and horizontal directions of original image data decreases in accordance with execution of the arithmetic operation. On the other hand, a size in a depth direction or a channel direction increases. In a case in which such an arithmetic operation is executed, in order to appropriately extract a feature quantity, several rows of image data would not be sufficient, and image data of the entire screen would be desirable. For this reason, it is preferable that the second machine learning arithmetic operation unit 900 should take image data stored in the memory 800 as input.

The second reasoning unit 920 performs a reasoning arithmetic operation for detecting whether a predetermined subject is shown in image data using a machine learning model on the basis of a feature map generated by the feature extracting unit 910. More specifically, the likelihoods for classes that have been learned with the intention of detecting targets in advance are output. Examples of the classes that are detection targets include a person, a vehicle, and the like, and specific objects may be set as detection targets, and a plurality of types may be configured to be able to be simultaneously detected. In addition to the classes, coordinates of an area in which a detection target is present may be configured to be able to be output as a bounding box.

The output processing unit 930 outputs a final detection result on the basis of the likelihood of each class output by the second reasoning unit 920. More specifically, a highest class is selected from the likelihoods for a plurality of classes, and that class is used as a final detection result. In a case in which likelihoods for all the classes are lower than a predetermined value, it is determined that a target to be detected is not included in the image data.

The arithmetic operation performed by the second machine learning arithmetic operation unit 900 has a bit precision of 8 bits or more and is an arithmetic operation using 16-bit floating-point numbers as an example. For this reason, an opportunity learning model that can be used in a general-purpose environment such as a GPU or like can be easily implemented, and a high degree of versatility can be easily realized.

All or some of the functions of the second machine learning arithmetic operation unit 900 may be realized using hardware such as an Application Specific Integrated Circuit (ASIC), a Programmable Logic Device (PLD), a Field-Programmable Logic Device (PLD), or a Field-Programmable Gate Array (FPGA).

For example, in order to configure each function of the second machine learning arithmetic operation unit 900, a processor that executes program processing and an accelerator that executes arithmetic operations relating to a neural network may be combined. More specifically, an accelerator for a neural network arithmetic operation used for repeatedly performing a convolution operation and the like may be used in combination with a processor.

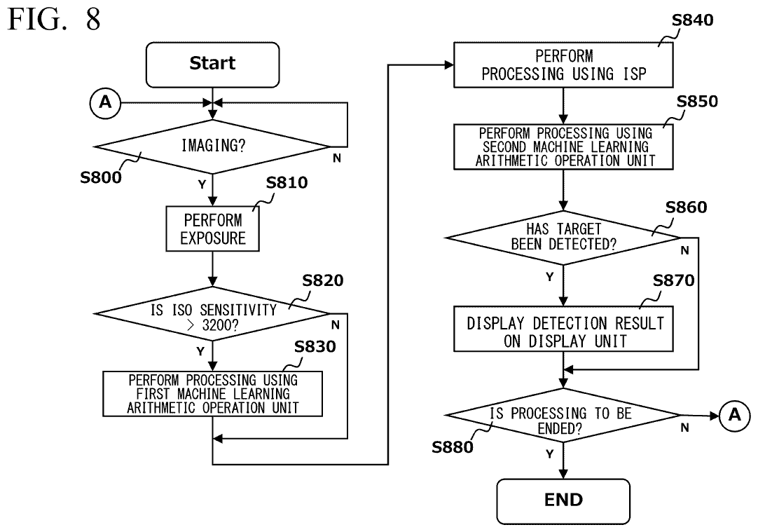

FIG. 8 is a flowchart for describing the imaging operation of the imaging device 1000. Each process of this flowchart is realized by a processor included in the CPU 700 executing a predetermined program stored in the memory 800 in advance and controlling each block of the imaging device 1000. In the imaging device 1000, the operation of this flowchart is started by pressing a power button or starting up a predetermined camera application.

When the process starts, in Step S800, the CPU 700 judges whether or not the imaging process is to be started. More specifically, in accordance of presence/absence or the like of a transition instruction for an imaging mode or an imaging start instruction of a shutter button or the like included in an operation unit not illustrated in the drawing, the process waits until a user instruction for performing imaging is received. Then, in a case in which the instruction for performing imaging has been received, the process is caused to proceed to a next step.

In Step S810, the CPU 700 performs control such that exposure is started for the sensor 100 through a sensor control unit not illustrated in the drawing. More specifically, the CPU 700 performs supply of power and a clock signal to the sensor 100, supply of a vertical synchronization signal or a horizontal synchronization signal, writing parameters into a control register inside the sensor 100, and the like. Here, the control register includes a register relating to exposure such as an exposure time, a gain, and the like and a register relating to read control such as pixel addition, thinning-out read, and the like. Then, on the basis of parameters written into the control register, a reset operation of electric charge generated by the pixels 110 of the sensor 100 and an accumulation operation of photoelectric charge are performed, and signals are sequentially read out from each pixel. After exposure control in the pixels 110 ends, the process is caused to proceed to a next step.

The reset operation of electric charge generated in the pixels 110 of the sensor 100 and an accumulation operation and a read operation of photoelectric charge will be further described. In this embodiment, for description, it is assumed that signals are read from the sensor 100 in a rolling shutter operation, and signals are read from the pixels 110 in units of one row. The read method and the read unit are merely one example. As a different example, as a read method, exposure and read may be performed in a global shutter operation as a read method, and, as a read unit, a plurality of rows or a predetermined block area may be used as one unit.

In Step S820, the CPU 700 judges exposure conditions on the basis of the parameters set for the sensor 100 in Step S800 and exposure information acquired in advance. In more detail, it is judged whether or not the ISO sensitivity used for imaging is a predetermined level or more. In this embodiment, in a case in which the ISO sensitivity used for imaging is greater than ISO3200, the process is caused to proceed to the process of Step S830, and, in a case in which the ISO sensitivity is equal to or less than ISO3200, the process is caused to proceed to the process of Step S840. As a judgment target in this step, not the ISO sensitivity but an analog gain value or a digital gain value set in the sensor 100 or an exposure time, or a combination thereof may be used. Each of the judgment conditions is a condition for judging whether or not the amount of noise included in a signal acquired from each pixel 110 is equal to or higher than a predetermined level, and as an example, judgment may be performed by adding a condition having a likelihood of causing an increase in the amount of noise such as a temperature, a type of the sensor 100, or the like.

In Step S830, the CPU 700 controls the first machine learning arithmetic operation unit 200 and performs an arithmetic operation process on a signal acquired from each pixel 110 using a machine learning model. The machine learning model according to this embodiment has learned in advance to reduce the amount of noise in a signal, and the CPU 700 controls the arithmetic operation by setting parameters of this machine learning model in registers and the like included in the first machine learning arithmetic operation unit 200. Then, after the arithmetic operation in the first machine learning arithmetic operation unit 200 ends, the process is caused to proceed to a next step. In this embodiment, a weight parameter used for a convolutional operation, a quantization parameter used for quantizing convolution operation results, a command used for controlling each block included in the first machine learning arithmetic operation unit 200, and the like are included in the parameters of the machine learning model.

In this embodiment, in the case of an exposure condition and the like in which much noise is included in a signal acquired from each pixel 110, more appropriate image data can be acquired by improving the signal quality of each signal by controlling the first machine learning arithmetic operation unit 200. On the other hand, in the case of an exposure condition and the like in which a noise component included in a signal is small, in a case in which there is no need to perform improvement of the signal quality in the first machine learning arithmetic operation unit 200, by performing a later-stage process without performing the process of the first machine learning arithmetic operation unit 200, improvement of the response speed and power saving can be achieved.

In this embodiment, for description, although an example in which it is controlled whether or not the process of the first machine learning arithmetic operation unit 200 is to be performed on the basis of whether or not the ISO sensitivity is equal to or higher than a predetermined level, the configuration is not limited thereto. As another example, the process of the first machine learning arithmetic operation unit 200 may be controlled such that switching among a plurality of machine learning models that have learned in accordance with an amount of noise or each ISO sensitivity is performed in accordance with an exposure condition. In more detail, it may be controlled such that a machine learning model that has learned on the basis of an image on which noise corresponding to ISO1600 is superimposed is used in a case in which the ISO sensitivity is between ISO800 and ISO3200, and a machine learning model that has learned on the basis of an image on which noise corresponding to ISO3200 is superimposed is used in a case in which the ISO sensitivity is ISO3200 or more. In addition, switching among three or more machine learning models may be performed, and some of the parameters such as a learning parameter and the like may be switched without performing switching among machine learning models.

In a case in which the machine learning model has learned to reduce blur, control may be performed in accordance with an exposure time for which there is a likelihood of occurrence of blur. As an example, in a case in which the exposure time is longer than 1/15 seconds, control may be performed such that a process using a machine learning model is performed.

In Step S840, the CPU 700 performs predetermined image processing on image data by controlling the ISP 400. In this embodiment, at least a demosaic process and an encoding compression process are executed. In accordance with this process, the ISP 400 generates compressed and encoded data for data storage or display by processing raw image data processed by the first machine learning arithmetic operation unit 200 and causes the process to proceed to a next step. As an example of the compressed and encoded data, not only a data format for a still image such as a JPEG format, a BMP format, or the like but also a data format for a moving image such as an MPEG format, an H.264 format, an H.265 format, or the like may be used. As the process of the ISP 400, in order to easily execute the arithmetic operation process of the second machine learning arithmetic operation unit 900, a treatment process such as cropping, size change, deformation, composition, and the like may be performed on the compressed and encoded data.

In Step S850, the CPU 700 controls the second machine learning arithmetic operation unit 900 to perform an arithmetic operation process using a machine learning model on the compressed and encoded data. The machine learning model according to this embodiment performs an arithmetic operation for detecting whether or not a predetermined detection target is present within an image. The CPU 700 controls the arithmetic operation by setting the parameters of this machine learning model in registers and the like included in the second machine learning arithmetic operation unit 900. Then, after the arithmetic operation in the second machine learning arithmetic operation unit 900 ends, the process is caused to proceed to a next step. In this embodiment, a weight parameter used in a convolution operation, a command used for controlling each block included in the second machine learning arithmetic operation unit 900, and the like are included in the parameters of the machine learning model. As illustrated in this embodiment, in a case in which the second machine learning arithmetic operation unit 900 performs a process on the compressed and encoded data, the data amount of the image data that is a processing target is reduced, and thus the storage capacity required for the memory 800 can be suppressed.

In this embodiment, in a case in which each block of the imaging device 1000 such as the ISP 400 is controlled in accordance with a target included in image data, detection of a target is appropriately performed by controlling the second machine learning arithmetic operation unit 900, and more appropriate control can be realized. In a case in which each block of the imaging device 1000 is controlled in accordance with a detection result, the block may be controlled to perform switching among a plurality of machine learning models. As an example, in a case in which the focal position of an optical unit, which is not illustrated in the drawing, is controlled in accordance with a detection result, a machine learning model detecting a distance to a detection target may be used. In addition, in a case in which the image processing in the ISP 400 is switched in accordance with a detection target, a machine learning model detecting an area occupied by the detection target within the image data may be used. In a case in which the imaging device 1000 is controlled using the posture and the like of a detection target as a user interface, a machine learning model detecting the posture of the detection target may be used. In addition, in a case in which authentication of a person and the like is performed, a machine learning model detecting at least a part of the human body may be used.

Since the machine learning model used in the second machine learning arithmetic operation unit 900 according to this embodiment needs to realize various functions, examples of capabilities required for the second machine learning arithmetic operation unit 900 include high versatility in addition to the arithmetic operation accuracy and the arithmetic operation speed. For this reason, circuit redundancy is also required in the second machine learning arithmetic operation unit 900.

In Step S860, the CPU 700 judges whether or not a detection target has been detected as a result of the arithmetic operation using the machine learning model in the second machine learning arithmetic operation unit 900. In a case in which a detection target has been detected, the process is caused to proceed to Step S870, and the detection result is displayed on the display unit 600. On the other hand, in a case in which no detection target has been able to be detected, the process is caused to proceed to Step S880. In this embodiment, although an example in which an arithmetic operation result of the machine learning model in the second machine learning arithmetic operation unit 900 is displayed on the display unit 600 has been illustrated, the configuration is not limited thereto. In accordance with the arithmetic operation result of the machine learning model in the second machine learning arithmetic operation unit 900 being used in control of a certain block of the imaging device 1000, the processes of Step S860 and Step S870 can be replaced. In this embodiment, although an example in which the processes of Step S850 to Step S870 are performed once is illustrated, the processes may be controlled to be repeated a predetermined number of times.

In Step S880, the CPU 700 judges whether or not the imaging operation is to be ended. In more detail, the CPU 700 judges whether or not the process of this flowchart is to be ended on the basis of an imaging end instruction or an application end instruction according to a user and repeatedly executes the process of this flowchart until judgment of the end is acquired.

As the imaging device 1000 and the method for controlling thereof according to this embodiment being described with reference to the drawings above, by including the first machine learning arithmetic operation unit 200 and the second machine learning arithmetic operation unit 900 that are arithmetic operation means of which features are different from each other, both high speed and versatility of the process can be achieved. In an arithmetic operation relating to normal machine learning, as a larger-scale processing device such as a server is required, it is necessary to execute a larger amount of multi-bit product-sum operations in parallel. Although there is a technique of performing a quantization process as a technique for reducing the amount of the arithmetic operation, when the bit accuracy is reduced through quantization, there is a new problem that the accuracy of the arithmetic operation is reduced in accordance therewith. In addition, in the arithmetic operation of machine learning, there is also a case in which the reduction of the accuracy of the arithmetic operation according to quantization is suppressed by restricting task to be executed to specific details or range. In other words, these exhibit that it is a very difficult problem to satisfy both a request for versatility to be able to execute various operations relating to machine learning with high accuracy and a request for high computing efficiency for suppressing the circuit scale and the power consumption in edge devices with limited power consumption and computing resources of embedded devices and the like.

In the imaging device 1000 according to this embodiment, for the object of achieving both the versatility and the computing efficiency, the first machine learning arithmetic operation unit 200 that is specialized for processing a signal acquired from each pixel for each pixel is disposed between the sensor 100 and the ISP 400 in a pipelined manner to raise the computing efficiency, and the second machine learning arithmetic operation unit having further higher versatility is disposed in a later stage of the ISP 400. In other words, the first machine learning arithmetic operation unit 200 executes an arithmetic operation with a low delay and high efficiency while suppressing the amount of consumption of the memory by executing a process using a machine learning model including a quantization operation in units of outputs from the sensor 100 on the basis of a synchronization signal. Furthermore, by restricting a task executed by the machine learning model to a process in units of pixels such a noise reduction, reduction of the accuracy of an arithmetic operation according to a quantization operation can be suppressed. Since multi-bit information is included in a signal output from the sensor 100, it is appropriate for executing image processing relating to the improvement of image quality. By further including the second machine learning arithmetic operation unit 900, it is also possible to maintain the versatility to respond to tasks in various machine learning models as a whole.

### Second Embodiment

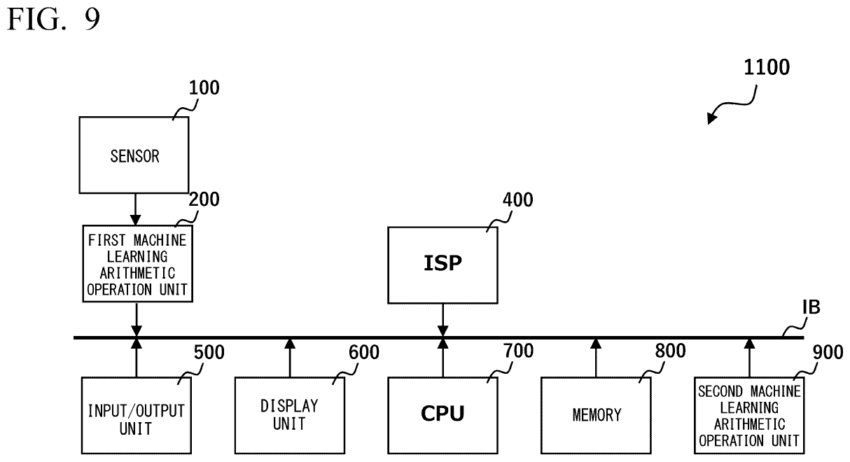

In the first embodiment, an example in which the first machine learning arithmetic operation unit 200 and the internal bus IB are connected through the sensor I/F 300 has been illustrated. FIG. 9 illustrates a functional block diagram of the imaging device 1100 according to a second embodiment. The same components as those of the imaging device 1000 according to the first embodiment are illustrated using the same reference signs, and description thereof may be omitted.

A part of the imaging device 1100 that differs from the imaging device 1000 according to the first embodiment is a connection form between a first machine learning arithmetic operation unit 200 and an internal bus IB. A sensor 100 and the first machine learning arithmetic operation unit 200 are connected using a high-speed multi-channel communication scheme via a high-speed I/F 130 of the sensor 100, which is similar to the first embodiment. On the other hand, the first machine learning arithmetic operation unit 200 is connected to each functional block of the imaging device 1100 using the internal bus IB capable of high-speed communication. In other words, in this embodiment, the first machine learning arithmetic operation unit 200, an ISP 400, an input/output unit 500, a display unit 600, a CPU 700, a memory 800, and a second machine learning arithmetic operation unit 900 are configured on the same silicon chip, and each thereof is connected to the high-speed internal bus IB.

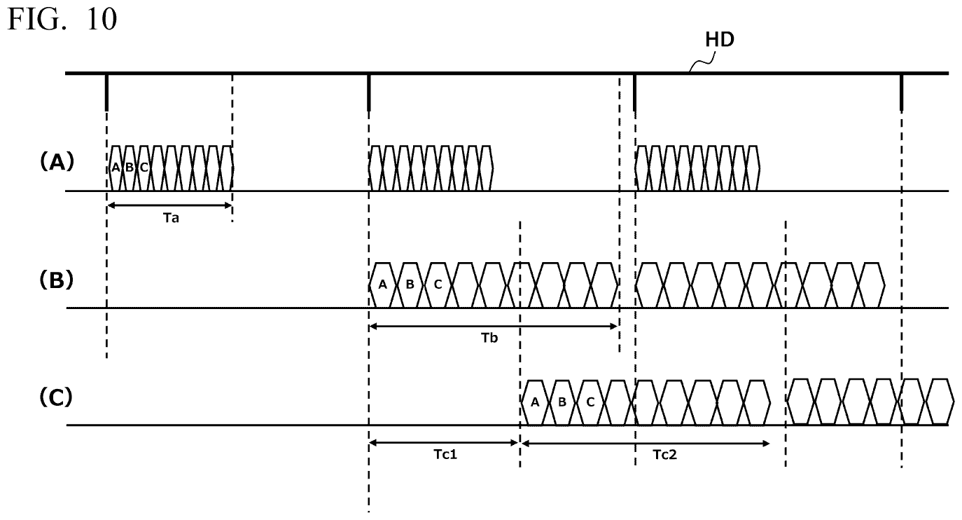

FIG. 10 is a timing chart for describing operations of a buffer 210 and the ISP 400 according to this embodiment. This embodiment illustrates an example in which pixel values corresponding to one row are buffered. FIG. 10A illustrates data output timings of pixel values output from the sensor 100. In synchronization with a timing of a horizontal synchronization signal, pixel value data is sequentially output in period Ta. FIG. 10B illustrates data output timings of pixel values output from the buffer 210. In synchronization with a timing of the horizontal synchronization signal, pixel value data is sequentially output in period Tb. In a later stage of the buffer 210, the lower the data rate to be processed, the more power reduction is achieved. For this reason, the data rate at which data is read from the buffer 210 is lower than the data rate at the time of inputting data. FIG. 10C illustrates an execution timing of image processing on image data in the ISP 400. A result processed by the first machine learning arithmetic operation unit 200 is input to the ISP 400 with being delayed from the timing illustrated in FIG. 10B (period Tc1). Then, image data input in period Tc2 is sequentially processed in a pipelined manner.

In FIG. 10, although an example in which the buffer 210 stores pixel values corresponding to one row has been described, the configuration is not limited thereto, and a plurality of rows may be configured to be stored in a case in which a plurality of rows is necessary for the first reasoning unit 230 and the ISP 400. For example, in a case in which the first reasoning unit 230 uses 3×3 weights for an arithmetic operation or the like, data corresponding to at least three rows may be stored. In addition, in a case in which image data corresponding to 7 rows is necessary for the ISP 400 or the like, data corresponding to at least 7 rows may be stored.

As illustrated in FIG. 10, by directly connecting the first machine learning arithmetic operation unit 200 to the internal bus IB, image data can be processed in a pipelined manner. In accordance with this, the entire process rate of the imaging device 1100 can be improved.

Although the second embodiment of the present invention has been described in detail with reference to the drawings as above, the specific configuration is not limited to this embodiment, and a design change and the like in the range not departing from the gist of the present invention are included therein. In addition, constituent elements represented in the embodiment described above and modified examples can be appropriately combined and configured.

### Third Embodiment

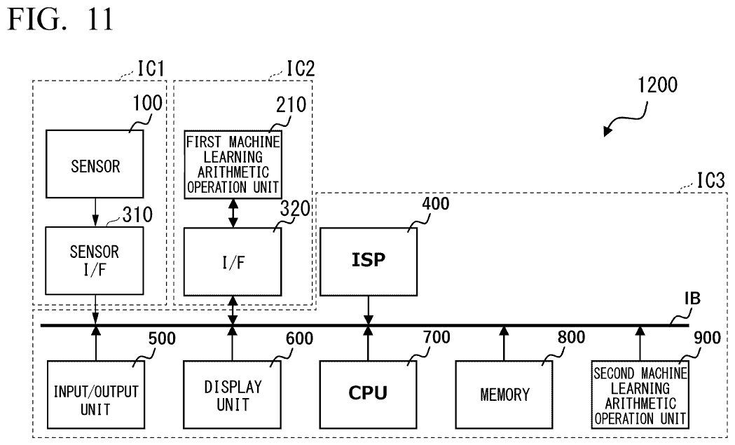

FIG. 11 is a diagram illustrating a functional block diagram of an imaging device 1200 according to a third embodiment. In description of the imaging device 1200, the same components as those of the imaging device 1000 or the imaging device 1100 are illustrated using the same reference signs, and description thereof may be omitted. The imaging device 1200 according to the third embodiment can be applied, for example, to an imaging device having a stacked CMOS image sensor and the like.

The imaging device 1200 is different from the imaging device 1000 and the imaging device 1100 that each of a sensor 100 and a first machine learning arithmetic operation unit 210 is independently connected to an internal bus IB. The first machine learning arithmetic operation unit 210 is a modified example of the first machine learning arithmetic operation unit 200. In addition, the imaging device 1200 is different from the imaging device 1000 and the imaging device 1100 that a sensor I/F 310 and an I/F 320 are included in place of the sensor I/F 300.

The sensor I/F 310 stores information (raw image data) output by the sensor 100 in a predetermined storage unit through the internal bus IB. The predetermined storage unit, for example, may be a memory 800.

The first machine learning arithmetic operation unit 210 takes raw image data stored in the predetermined storage unit, for example, the memory 800 as input and executes an arithmetic operation using a predetermined machine learning model on this input. In addition, the first machine learning arithmetic operation unit 210 may directly take raw image data as input not though the memory 800 and the like via the sensor I/F 310 and execute an arithmetic operation using a predetermined machine learning model on this input. The internal configuration of the first machine learning arithmetic operation unit 210 may be similar to that of the first machine learning arithmetic operation unit 200.

The I/F 320 outputs an output of the first machine learning arithmetic operation unit 210 to the internal bus IB. The data output to the internal bus IB, for example, is stored in the memory 800. The I/F 320 may output data acquired from the first machine learning arithmetic operation unit 210 to an ISP 400 for executing predetermined image processing on the data. In addition, the I/F 320 may include a buffer that is used for temporarily storing data for performing conversion of a data format and the like. Furthermore, although the I/F 320 is configured to be connected to the internal bus IB, when a low-delay communication scheme can be used at a sufficiently high speed as in case of a high-speed serial communication standard, the I/F 320 may be configured to be connected to the internal bus IB through a predetermined communication I/F.

Here, as a specific implementing means of the components according to this embodiment, the components may be divided and mounted in three integrated circuits (ICs) as illustrated in the drawing. Integrated circuit ICI has the functions of the sensor 100 and the sensor I/F 310. Integrated circuit IC2 has the functions of the first machine learning arithmetic operation unit 200 and the I/F 320. Integrated circuit IC3 has the functions of the ISP 400, the input/output unit 500, the display unit 600, the CPU 700, the memory 800, and the second machine learning arithmetic operation unit 900. Integrated circuit IC1, Integrated circuit IC2, and Integrated circuit IC3 may be electrically connected to each other through the internal bus IB so as to be able to perform data communication with each other.

### Fourth Embodiment

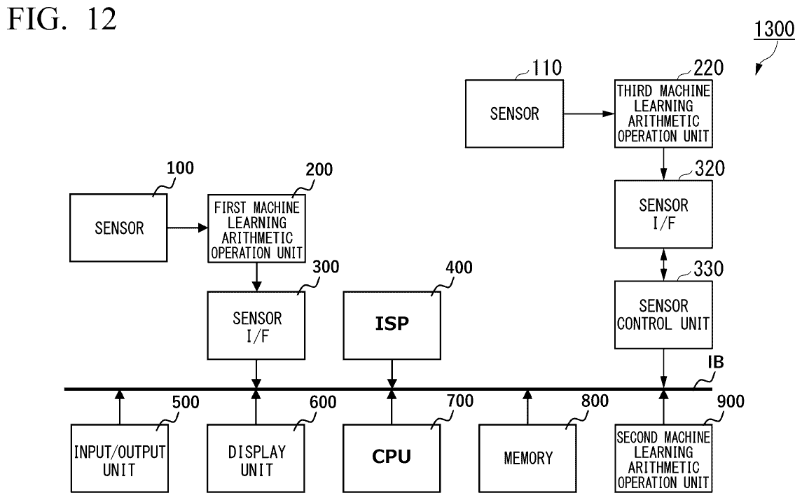

FIG. 12 is a diagram illustrating a functional block diagram of an imaging device 1300 according to a fourth embodiment. In description of the imaging device 1300, the same components as those of the imaging device 1000 are illustrated using the same reference signs, and description thereof may be omitted. The imaging device 1300 is different from the imaging device 1000 that a sensor 110, a third machine learning arithmetic operation unit 210, a sensor I/F 320, and a sensor control unit 330 are included. The imaging device 1300 according to the fourth embodiment, for example, can be applied to a control device and the like controlling a vehicle. In the control device and the like controlling a vehicle, there is a demand for shortening an occupant time of an internal bus IB as possibly.

Similarly to the sensor 100, the sensor 110 is a sensor that captures an image and is a sensor that is different from the sensor 100. In other words, the imaging device 1300 has a plurality of sensors. In a case in which the imaging device 1300 is applied to a control device controlling a vehicle, the sensor 100 may be a sensor that images the front side of the vehicle, and the sensor 110 may be a sensor imaging the rear side of the vehicle and have an angle of view partly overlapping with the angle of view imaged by the sensor 100. In addition, the imaging device 1300 may further have a plurality of sensors not illustrated in the drawing. The sensor 110 outputs to the third machine learning arithmetic operation unit 220 without being output to the internal bus IB.

The third machine learning arithmetic operation unit 220 takes information (raw image data) output by the sensor 110 as input and executes an arithmetic operation using a predetermined machine learning model. The third machine learning arithmetic operation unit 220, for example, may have a configuration similar to that of the second machine learning arithmetic operation unit 900 and may perform object detection, posture detection, object recognition, and object tracking based on feature quantities and the like, reduction of blurring within an image, a process of reducing optical aberrations, and the like.

The sensor I/F 320 outputs an output result of the third machine learning arithmetic operation unit 220 to the sensor control unit 330. The sensor control unit 330 outputs a result of the arithmetic operation performed by the third machine learning arithmetic operation unit 220 to the internal bus IB. Here, the result of the arithmetic operation performed by the third machine learning arithmetic operation unit 220, for example, may be information of a class, a likelihood, and the like in a case in which the third machine learning arithmetic operation unit 220 performs object detection. In other words, according to this embodiment, only the information of a class, a likelihood, and the like acquired as a result of the machine learning is output, and thus image data is not output to the internal bus IB. Therefore, according to this embodiment, the capacity of data output to the internal bus IB can be reduced, and the occupant time of the internal bus IB can be shortened. Therefore, according to this embodiment, also in a case in which a plurality of sensors are included, occurrence of a delay due to congestion of the internal bus IB can be suppressed.

### Modified Example 1

For example, data that is an arithmetic operation target for the first machine learning arithmetic operation unit 200 and the second machine learning arithmetic operation unit 900 described in the embodiment described above is not limited to a single format and may consist of still images, moving images, audio, text, numerical values, and a combination thereof. The data input to the first machine learning arithmetic operation unit 200 and the second machine learning arithmetic operation unit 900 may be combined with measurement results acquired by a physical quantity measuring device such as a light sensor, a thermometer, a Global Positioning System (GPS) measuring device, an angular velocity measuring device, an anemometer, or the like.

The input data may be combined with different types of information such as surrounding information including base station information, information of vehicles, vessels, and the like, weather information, information on a congested status, and the like, financial information, personal information, and the like received from surrounding devices via wires or wireless communication.

### Modified Example 2

Although the imaging device 1000 or the imaging device 1100 is assumed to be a communication device such as a mobile phone driven by a battery, a smart device such as a personal computer, or a mobile device such as a digital camera, a gaming device, or a robot product, it is not limited thereto. In a case in which the imaging device described above is used in a product having a high demand for peak power limit of power that can be supplied in a power-on Ethernet (POE) or the like or a product having a high demand for reduction of product heat generation or long-time driving, effects not present in other prior examples can be acquired.

For example, by applying the imaging device described above to an in-vehicle camera mounted in a vehicle or a ship, a monitoring camera disposed in a public facility, on the road, or the like, and the like, not only long-time imaging can be realized, but also it can also contribute to weight reduction and high durability. In addition, by applying the imaging device described above also to a display device such as a television set or a display, a medical device such as a medical camera or a surgical robot, and a work robot used in a manufacturing site or a construction site, similar effects can be acquired.

### Modified Example 3

The first machine learning arithmetic operation unit 200 and the second machine learning arithmetic operation unit 900 may be partially or fully realized using one or more processors. For example, in the first machine learning arithmetic operation unit 200 and the second machine learning arithmetic operation unit 900, a part or the whole of the input layer or the output layer may be realized by software processing using a processor. A part of the input layer or the output layer that is realized by the software processing, for example, is normalization or conversion of data. In accordance with this, input formats or output formats of various formats can be responded. In addition, software executed by a processor may be configured to be rewritable using a communication means and an external medium.

### Modified Example 4

Part of the process in the second machine learning arithmetic operation unit 900 may be realized in combination of a Graphics Processing Unit (GPU) on a cloud and the like. In addition to the process performed by the imaging device 1000 or the imaging device 1100, by further performing a process on the cloud or performing a process in addition to the process on the cloud, the second machine learning arithmetic operation unit 900 can realize a more complex process with fewer resources.

### Modified Example 5

Since there is a difference between the first machine learning arithmetic operation unit 200 and the second machine learning arithmetic operation unit 900 on the basis of whether or not a quantization operation is included, and thus, the learning method may be configured to be different for a machine learning model operating in each machine learning arithmetic operation unit. As an example, it is appropriate for the machine learning model operating in the first machine learning arithmetic operation unit 200 to employ a method including a learning step that performs learning in a form including a quantization operation after generation of a network including the quantization operation (hereinafter referred to as a QAT scheme). In this way, by performing learning in the QAT scheme, a decrease in the accuracy of the arithmetic operation according to quantization can be reduced. On the other hand, since the QAT scheme requires a learning method, design of learning parameters, and the like, the versatility may be reduced. For this reason, in a machine learning model operating in the second machine learning arithmetic operation unit 900, it is preferable to perform learning without using the QAT scheme. In this way, it is preferable to determine a learning method of a machine learning model depending on which one of the first machine learning arithmetic operation unit 200 and the second machine learning arithmetic operation unit 900 is used.

The effects described in this specification are illustrative or exemplary only and not limiting. In other words, the technology according to the present disclosure may produce other effects that are obvious to those skilled in the art from the description of this specification either together with or in place of the effects described above.

### REFERENCE SIGNS LIST

100 Image sensor
200 First machine learning arithmetic operation unit
300 Sensor I/F
400 ISP
500 Input/output unit
600 Display unit
700 CPU
800 Memory
900 Second machine learning arithmetic operation unit
1000 Imaging device according to first embodiment
1100 Imaging device according to second embodiment

1. An imaging device including an image sensor that includes a plurality of pixels used for converting a subject image into an electrical signal, the imaging device comprising:
a first machine learning arithmetic operation means for processing signals acquired from the plurality of pixels using a first machine learning model including a plurality of arithmetic operation layers;
a determination means for determining whether or not processing is executed using the first machine learning arithmetic operation means; and
a second machine learning arithmetic operation means for processing on the basis of the signals or a processing result acquired by the first machine learning arithmetic operation means using a second machine learning model different from the first machine learning model,
wherein the first machine learning model includes a quantization operation layer performing a quantization operation on an arithmetic operation result of a convolution operation layer performing at least a convolution operation.

2. The imaging device according to claim 1, wherein the second machine learning model has a network structure different from the first machine learning model and includes a convolution operation layer performing at least a convolution operation and a pooling layer performing a pooling operation on a convolution operation result.

3. The imaging device according to claim 1, further comprising a control means for generating a synchronization signal used for controlling the image sensor, wherein processing in the first machine learning arithmetic operation means is performed in synchronization with the synchronization signal.

4. The imaging device according to claim 1, wherein the quantization operation layer included in the first machine learning model quantizes an operation result of the convolution operation layer into a value of 8 bits or less.

5. The imaging device according to claim 1,
wherein the image sensor further includes a conversion means for converting analog signals of the plurality pixels into digital signals, and
wherein the quantization operation layer included in the first machine learning model quantizes an operation result of the convolution operation layer into a value equal to or less than resolution of the conversion means.

6. The imaging device according to claim 1, further comprising an image processing means for performing predetermined image processing on signals processed by the first machine learning arithmetic operation means, wherein at least a demosaic process and an encoding compression process are included in the predetermined image processing performed by the image processing means.

7. The imaging device according to claim 6,
wherein the first machine learning model performs a reasoning arithmetic operation used for reducing noise included in the signals of the plurality of pixels, and
wherein the second machine learning model performs a process of detecting a predetermined detection target in image data that is a result acquired by the image processing means.

8. The imaging device according to claim 7, further comprising a display means for displaying the image data that is the result acquired by the image processing means, wherein the display means displays a detection result of a detection target of the second machine learning model that corresponds to the image data displayed in the display means.

9. The imaging device according to claim 6, further comprising a storage means for storing image data that is a result acquired by the image processing means,
wherein the first machine learning arithmetic operation means performs a reasoning arithmetic operation on the signals of the plurality of pixels in a predetermined unit output by the image sensor, and
wherein the second machine learning arithmetic operation means performs a process of detecting a predetermined detection target in units of image data stored in the storage means.

10. The imaging device according to claim 9,
wherein 1500 or more pixel values of 8 bits or more are included in the predetermined unit, and
wherein the first machine learning arithmetic operation means and the image processing means sequentially perform processing in a pipelined manner on the basis of the unit.

11. The imaging device according to claim 9,
wherein the first machine learning arithmetic operation means further includes a buffer means for temporarily storing the signals of the plurality of pixels in a predetermined unit output by the image sensor, and
wherein a data rate at which the signals are read by the first machine learning arithmetic operation means for performing processing using the first machine learning model on the signals of the plurality of pixels that are temporarily stored in the buffer means is lower than a data rate of the signals of the plurality of pixels at the time of inputting the signals to the buffer means.

12. The imaging device according to claim 1,
wherein the first machine learning arithmetic operation means further includes a switching means for switching among a plurality of machine learning models, and
wherein the first machine learning arithmetic operation means performs switching of the machine learning model on the basis of exposure conditions of the image sensor.

13. The imaging device according to claim 12,
wherein the second machine learning arithmetic operation means further includes a switching means for switching among a plurality of machine learning models, and
wherein the plurality of machine learning models switched by the second machine learning arithmetic operation means include machine learning models detecting at least a part of a human body.

14. The imaging device according to claim 1,
wherein the first machine learning model of the first machine learning arithmetic operation means is a learned machine learning model that has learned in advance in an external device using a learning method different from that of the second machine learning model, and
wherein a learning step performed in a form in which a quantization operation is included in the first machine learning model is included in the learning method.

15. The imaging device according to claim 1, further comprising:
a sensor acquiring an image; and
a third machine learning arithmetic operation means for performing a predetermined detection process based on the image acquired by the sensor,
wherein the third machine learning arithmetic operation means outputs a detection result.

16. A method for controlling an imaging device including an image sensor that includes a plurality of pixels used for converting a subject image into an electrical signal, the method comprising:
a first machine learning arithmetic operation step of processing signals of the plurality of pixels using a first machine learning model including a plurality of arithmetic operation layers;
a determination step of determining whether or not processing is executed using the first machine learning arithmetic operation step; and
a second machine learning arithmetic operation step of processing on the basis of the signals or a processing result acquired by the first machine learning arithmetic operation step using a second machine learning model different from the first machine learning model,
wherein the first machine learning model includes a quantization operation step of performing a quantization operation on an arithmetic operation result of a convolution operation layer performing at least a convolution operation.
